(19) United States
(12) Patent Application Publication
(10) Pub. No.: US 2026/0322538 A1
(43) Pub. Date: Oct. 15, 2026

(54) TECHNIQUES FOR USING ON-OFF KEYING WAVEFORM TO INDICATE FEEDBACK IN WIRELESS COMMUNICATIONS

(71) Applicant: QUALCOMM Incorporated, San Diego, CA (US)

(72) Inventors: Ran BERLINER, kfar aviv (IL); Konstantin KUPERSHLAK, Ramat Gan (IL); Shay LANDIS, Hod Hasharon (IL); Amit BAR-OR TILLINGER, Tel-Aviv (IL); Eitan YERUSHALMI, Tel Aviv (IL)

(21) Appl. No.: 19/177,439

(22) Filed: Apr. 11, 2025

(51) Int. Cl. H04L 1/1829

(52) U.S. Cl. CPC H04L 1/1864

(57) ABSTRACT

Aspects described herein relate to using on-off keying (OOK) for indicating feedback in wireless communications. A first wireless node can obtain one or more transmissions from a second wireless node and can generate one or more feedback values each associated with one of the one or more transmissions, each feedback value of the one or more feedback values indicating either an acknowledgement (ACK) or negative-ACK (NACK). When all of the one or more feedback values associated with at least a portion of the one or more transmissions associated with reporting in an upcoming feedback transmission resource are of a same certain feedback value, the first wireless node can refrain from outputting a feedback for transmission in the upcoming feedback transmission resource to indicate the same certain feedback value. The second wireless node can accordingly process feedback based on whether feedback is received in an associated feedback transmission resource.

### BACKGROUND

### Technical Field

The present disclosure generally relates to communication systems, and more particularly, to indicating feedback for received wireless communications.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects are directed to an apparatus for wireless communication. In some examples the apparatus includes one or more memories, individually or in combination, having instructions. In some examples, the apparatus includes one or more processors, individually or in combination, configured to execute the instructions. In some examples, the apparatus is configured to obtain one or more transmissions from a second wireless node, generate one or more feedback values, each feedback value being associated with one of the one or more transmissions and indicating either an acknowledgement (ACK) that the transmission is successfully decoded or a negative acknowledgement (NACK) that the transmission is not successfully decoded, wherein the one or more feedback values are associated with reporting, to the second wireless node, via an upcoming transmission resource, and when all of the one or more feedback values are of a certain value, refrain from outputting a feedback for transmission via the upcoming transmission resource, wherein the certain value is one of ACK or NACK, or when at least one of the one or more feedback values is different from the certain value, output a feedback for transmission via the upcoming transmission resource.

Other aspects are directed to an apparatus for wireless communication. In some examples the apparatus includes one or more memories, individually or in combination, having instructions. In some examples, the apparatus includes one or more processors, individually or in combination, configured to execute the instructions. In some examples, the apparatus is configured to output, for transmission to a second wireless node, signaling to configure the second wireless node to refrain from transmitting a feedback when all of one or more feedback values in the feedback are of a certain value, output, for transmission to the second wireless node, one or more transmissions, and when a feedback associated with the one or more transmissions is not obtained from the second wireless node and when the certain value is ACK, output for transmission, to the second wireless node, a new transmission, when the feedback associated with the one or more transmissions is not obtained from the second wireless node and when the certain value is NACK, output for transmission, to the second wireless node, a retransmission of each of the one or more transmissions; or when the feedback associated with the one or more transmissions is obtained, output, for transmission to the second wireless node and responsive to a feedback value associated with each transmission of the one or more transmissions as indicated in the feedback, a new transmission or a retransmission of each of the one or more transmissions.

Other aspects are directed to a method for wireless communications at a first wireless node that includes obtaining one or more transmissions from a second wireless node, generating one or more feedback values, each feedback value being associated with one of the one or more transmissions and indicating either an ACK that the transmission is successfully decoded or a NACK that the transmission is not successfully decoded, wherein the one or more feedback values are associated with reporting, to the second wireless node, via an upcoming transmission resource, and when all of the one or more feedback values are of a certain value, refraining from outputting a feedback for transmission via the upcoming transmission resource, wherein the certain value is one of ACK or NACK, or when at least one of the one or more feedback values is different from the certain value, outputting a feedback for transmission via the upcoming transmission resource.

Other aspects are directed to a method for wireless communications at a first wireless node that includes outputting, for transmission to a second wireless node, signaling to configure the second wireless node to refrain from transmitting a feedback when all of one or more feedback values in the feedback are of a certain value, outputting, for transmission to the second wireless node, one or more transmissions, and when a feedback associated with the one or more transmissions is not obtained from the second wireless node and when the certain value is ACK, outputting for transmission, to the second wireless node, a new transmission, when the feedback associated with the one or more transmissions is not obtained from the second wireless node and when the certain value is NACK, outputting for transmission, to the second wireless node, a retransmission of each of the one or more transmissions; or when the feedback associated with the one or more transmissions is obtained, outputting, for transmission to the second wireless node and responsive to a feedback value associated with each transmission of the one or more transmissions as indicated in the feedback, a new transmission or a retransmission of each of the one or more transmissions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example disaggregated base station architecture.

FIG. 5 illustrates a graph indicating a rate of generating all acknowledgements (ACKs) for hybrid automatic repeat/request (HARQ) feedback per HARQ feedback payload bit length for different block error rates (BLERs), in accordance with aspects described herein.

FIG. 6 is a call-flow diagram illustrating an example of communications between a UE and a network entity using on-off keying (OOK) to convey HARQ feedback where all values of the HARQ feedback payload are ACK, in accordance with aspects described herein.

FIG. 7 is a call-flow diagram illustrating an example of communications between a UE and a network entity using OOK to convey HARQ feedback where all values of the HARQ feedback payload are negative-ACK (NACK), in accordance with aspects described herein.

FIG. 8 is a call-flow diagram illustrating an example of communications between a UE and a network entity using OOK with ambiguity resolution to convey HARQ feedback where all values of the HARQ feedback payload are ACK, in accordance with aspects described herein.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In some wireless communication systems, such as fifth generation (5G) new radio (NR) and/or other third generation partnership project (3GPP)-based technologies, a first device can transmit feedback to a second device to indicate whether the first device successfully received a wireless communication from the second device or not. One feedback technology includes hybrid automatic repeat/request (HARQ) feedback, where a user equipment (UE) can transmit, over an uplink channel, feedback to a base station or gNB for communications received from the base station or gNB over a downlink channel. In another example, a UE can transmit HARQ feedback to another UE over a sidelink channel for communications received from the other UE over a sidelink channel. The network entity (e.g., base station or gNB) or sidelink UE that receives the HARQ feedback can determine whether to retransmit the communication and/or transmit a new communication based on a value of the HARQ feedback. In some example, the value of the HARQ feedback can be acknowledgement (ACK) to indicate the communication is successfully decoded, or negative-ACK (NACK) to indicate the communication is not successfully decoded.

In some wireless communications, such as 5G NR, link adaptation can relate to a dynamic adjustment of communication parameters to optimize a wireless link between a transmitter (e.g., a network entity) and a receiver (e.g., a UE). This process may include modifying parameters such as modulation schemes, coding rates, multiple-input multiple-output (MIMO) layers, and/or transmission power based on the current conditions of a wireless channel. Ultimately, a primary purpose of link adaptation can be to maximize data throughput and maintain a reliable connection by adapting to various channel conditions caused by interference, signal fading, mobility, etc.

Generally, a network entity can apply link adaptation to achieve a target block error rate (BLER) on a physical downlink shared channel (PDSCH) per carrier. For example, the target BLER target can less than or equal to 10%, meaning that the UE is expected to successfully decode at least 90% of the data blocks transmitted to it from the network entity. Network entity behavior may be the same when the UE transmits a single bit HARQ feedback of NACK or when the UE does not transmit feedback (which can be referred to as discontinuous transmit (DTX) and may be due to misdetection of downlink control information (DCI) at the UE). Indeed, in some examples, when HARQ feedback from a UE includes more than a single bit, the UE can send NACK as place holders when DTX is detected (for both semi-static or dynamic codebooks). Thus, there does not appear to be a distinction between NACK and DTX for multi bit HARQ feedback (in 5G NR or other 3GPP-based wireless communication technologies) or for single bit HARQ feedback based on network entity behavior.

On-off keying (OOK) refers to indicating a value by transmitting or not transmitting a scheduled communication, or by receiving or not receiving the scheduled communication. OOK is used for various purposes in 3GPP-based wireless communication technologies. For example, in 5G NR, OOK is used for Scheduling Request (SR), where the UE transmits a physical uplink control channel (PUCCH) in the PUCCH resource for the corresponding SR configuration only when the UE transmits a positive SR using PUCCH format 0 or PUCCH format 1. OOK is used for paging monitoring indication during connected mode discontinuous receive (C-DRX) using low power wakeup signal (LP-WUS), which is an OOK waveform with overlaid orthogonal frequency division multiplexing (OFDM) sequence for conveying the wakeup indication and secondary component carrier (SCC) dormancy indication if transmitted. For example, in fourth generation (4G) wireless communication technologies, OOK is used for SR only, while transmitting PUCCH format 1 for positive SR on the SR resources. In another example, in 4G wireless communication technologies, explicit OOK is used for the case that SR and ACK/NACK are transmitted on same subframe, in which the transmission can use either the SR resources (for positive SR) or the ACK/NACK resources (for negative SR). In 5G NR and/or 4G wireless communication technologies, random access channel (RACH) communications may also be considered as OOK with overlaid OFDM signal, which conveys additional info (e.g., the RACH sequence number).

Aspects described herein relate to efficient mapping rules to map control channel communications with HARQ feedback payload to an OOK waveform, which can save significant amount of control channel transmissions as compared to transmitting the same HARQ feedback value for each control channel transmission. For example, in a first mode, the UE can use DTX for PUCCH to convey HARQ feedback payload having all ACK values. In this mode, the UE can transmit PUCCH to convey HARQ feedback payload where at least one HARQ feedback value is NACK. For example, in a second mode, the UE can use DTX for PUCCH to convey HARQ feedback payload having all NACK values. In this mode, the UE can transmit PUCCH to convey HARQ feedback payload where at least one HARQ feedback value is ACK. In another example, in the first mode or the second mode, the UE can transmit PUCCH to convey HARQ feedback regardless of the HARQ feedback values at certain times for ambiguity resolution. For example, the UE can transmit PUCCH to convey HARQ feedback for every n DCI (e.g., as received from the network entity), where n is a positive integer, or every instance at a defined time window. Though mainly described herein as the UE using OOK to transmit PUCCH to convey HARQ feedback, a network entity can similarly use OOK to transmit PDCCH to convey HARQ feedback, a sidelink UE can similar use OOK to transmit (physical sidelink control channel (PSCCH) to convey HARQ feedback, etc.

For example, mapping PUCCH with HARQ feedback payload to the OOK waveform can achieve uplink (UL) power savings (e.g., to a larger extent in downlink centric traffic scenarios), reduce inter-UE uplink interference that may otherwise be caused for multiplexed PUCCH over same resources, reduce cross-cell UE UL interference, etc. Similar advantages can be achieved for a network entity mapping physical downlink control channel (PDCCH) with HARQ feedback payload to the OOK waveform. In addition, the lack of distinction of a network entity between NACK and DTX can be exploited for simplification of the OOK waveform design.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

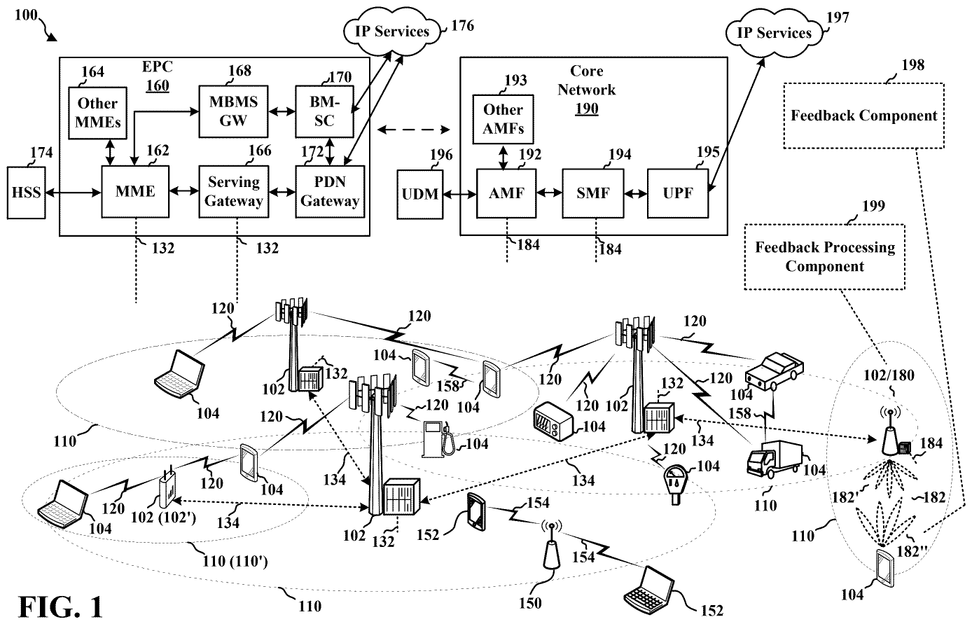

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave gNB 180 (or base station 102) may utilize beamforming 182 with the UE 104 to compensate for the path loss and short range. The gNB 180 and the UE 104 may each include a plurality of antennas, such as antenna elements, antenna panels, and/or antenna arrays to facilitate the beamforming.

The gNB 180 (or base station 102) may transmit a beamformed signal to the UE 104 in one or more transmit directions 182′. The UE 104 may receive the beamformed signal from the gNB 180 in one or more receive directions 182′. The UE 104 may also transmit a beamformed signal to the gNB 180 in one or more transmit directions. The gNB 180 may receive the beamformed signal from the UE 104 in one or more receive directions. The gNB 180/UE 104 may perform beam training to determine the best receive and transmit directions for each of the gNB 180/UE 104. The transmit and receive directions for the gNB 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A wireless node may comprise a UE, a base station, or a network entity.

Referring again to FIG. 1, the UE 104 may include a feedback component 198 configured for generating and indicating feedback through OOK. As described in more detail elsewhere herein, the feedback component 198 may be configured to: generate multiple feedback values for multiple transmissions received from a base station 102/gNB 180, and when the multiple feedback values are of the same value associated with an operating mode (e.g., one of ACK or NACK), feedback component 198 can refrain from outputting the feedback for transmission to the base station 102/gNB 180 such to indicate the feedback values using OOK. When the multiple feedback values include at least one feedback value that is not of the same value associated with the operating mode, feedback component 198 can transmit the generated feedback values to the base station 102/gNB 180 in an upcoming feedback transmission resource that is scheduled for feedback transmissions. Additionally, or alternatively, the feedback component 198 may perform one or more other operations described herein.

The base station 102/gNB 180 may include a feedback processing component 199 configured for processing feedback for a UE 104 based on OOK. As described in more detail elsewhere herein, the feedback processing component 199 may be configured to process a feedback value associated with each of multiple transmissions transmitted to the UE 104 as feedback of a same value associated with an operating mode (e.g., one of ACK or NACK) when feedback is not received from the UE 104 in an upcoming feedback transmission resource that is scheduled for feedback transmissions. Additionally, or alternatively, the feedback processing component 199 may perform one or more other operations described herein.

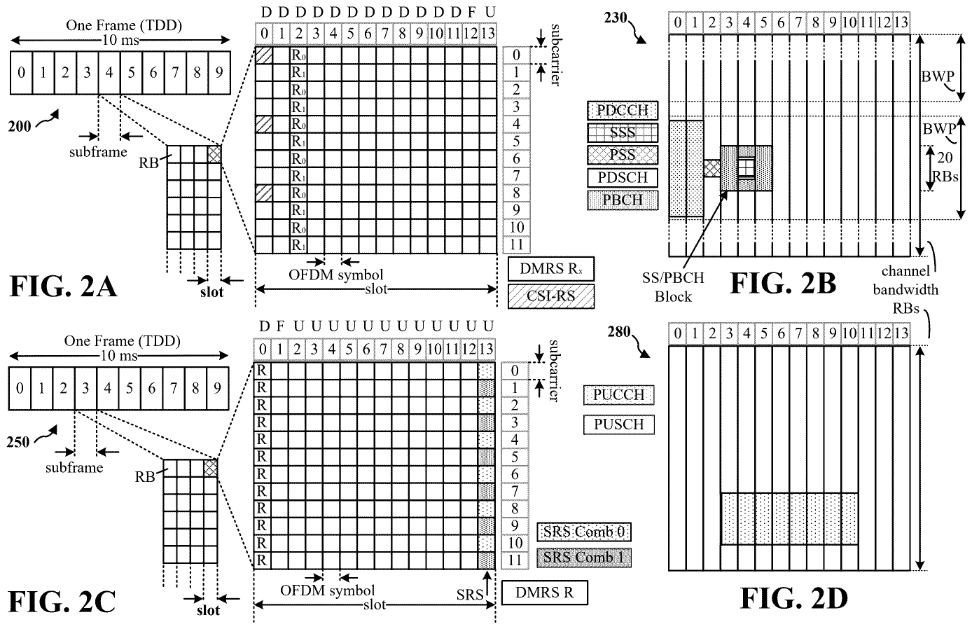

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ}slots/subframe. The subcarrier spacing and symbol length/duration are a function of the numerology. The subcarrier spacing may be equal to 2^{μ}*15 kilohertz (kHz), where μis the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

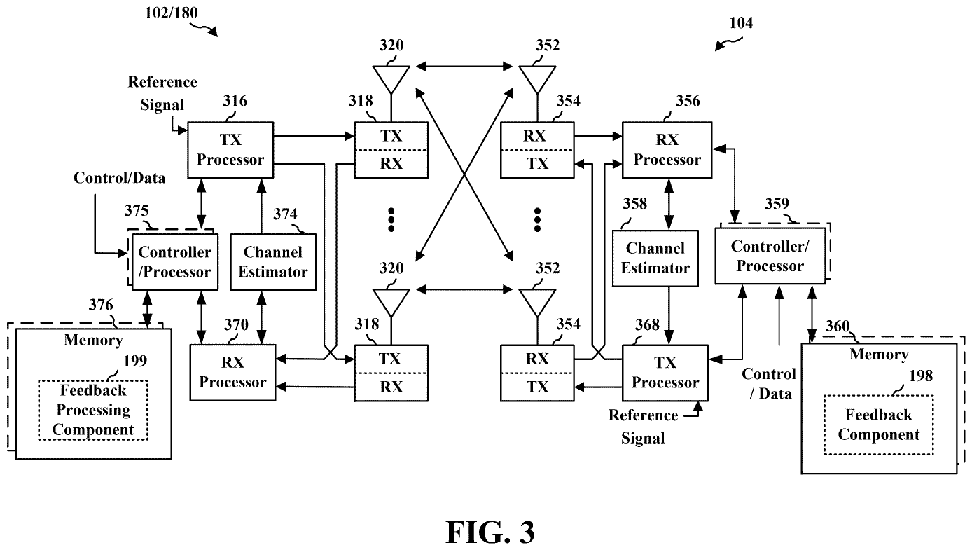

FIG. 3 is a block diagram of a base station 102/gNB 180 in communication with a UE 104 in an access network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102/gNB 180. These soft decisions may be based on channel estimates computed by the channel estimator 358. The soft decisions are then decoded and deinterleaved to recover the data and control signals that were originally transmitted by the base station 102/gNB 180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102/gNB 180, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/gNB 180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/gNB 180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with a feedback component 198 (or feedback processing component 199) of FIG. 1.

At least one of the TX processor 316, the RX processor 370, and the controller/processor 375 may be configured to perform aspects in connection with a feedback processing component 199 (or feedback component 198) of FIG. 1.

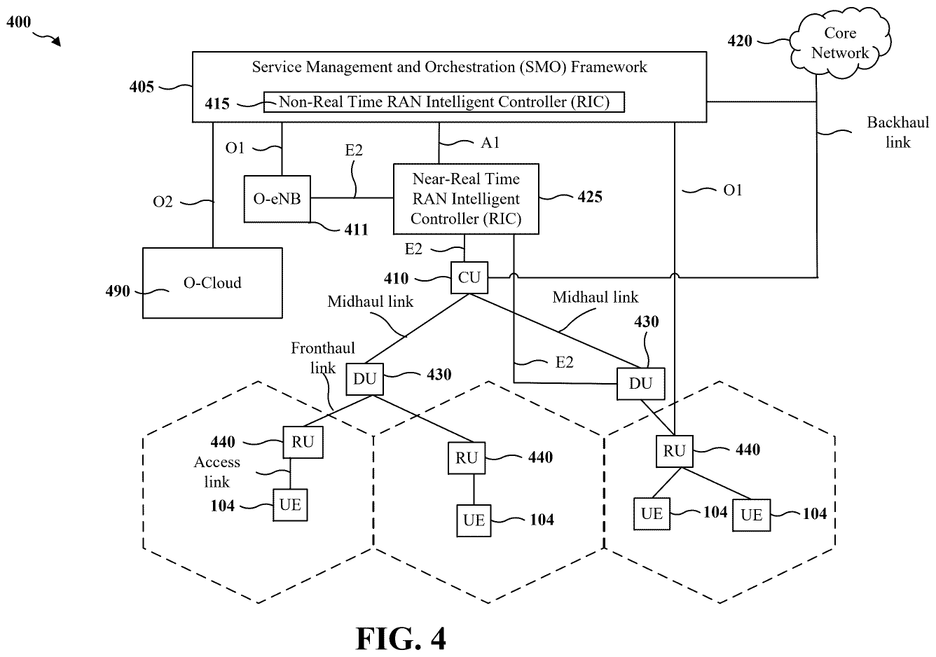

FIG. 4 is a block diagram illustrating an example disaggregated base station 400 architecture. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include one or more receivers, one or more transmitters or transceivers (such as one or more radio frequency (RF) transceivers), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control-plane functionality (i.e., central unit-control-plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via O1) or via creation of RAN management policies (such as A1 policies).

### Examples of Target BLER for Different HARQ Feedback Payload Bit Lengths

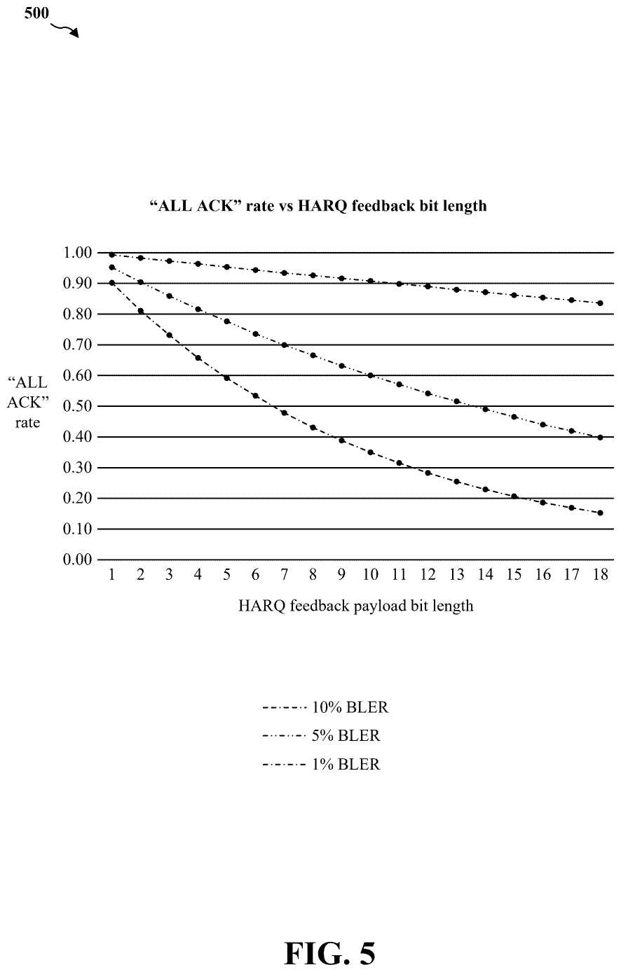

FIG. 5 illustrates a graph 500 indicating a rate of generating all ACKs for HARQ feedback per HARQ feedback payload bit length for different BLERs, in accordance with aspects described herein. In graph 500, the probability of all ACKs being generated for HARQ feedback payload can be a function of payload length at a given BLER working point. For example, for HARQ feedback payload lengths of {1, 8, 18} bits, the probabilities of generating all ACKs for as HARQ feedback for corresponding received transmissions at 10% BLER would be around {90%, 43%, 15%}. Thus, when OOK is used to indicate HARQ feedback of all ACKs (e.g., the UE uses DTX or does not transmit feedback when all generated feedback values are ACK), about 90% of the PUCCH would be DTX for 1 bit HARQ feedback payload length, about 43% of the PUCCH would be DTX for 8 bit HARQ feedback payload length, about 15% of the PUCCH would be DTX for 18 bit HARQ feedback payload length, etc., which can lead to a significant reduction in communication and/or associated power resources that would otherwise be used to transmit the PUCCH with HARQ feedback payload.

### Examples of Indicating Feedback Using On-Off Keying

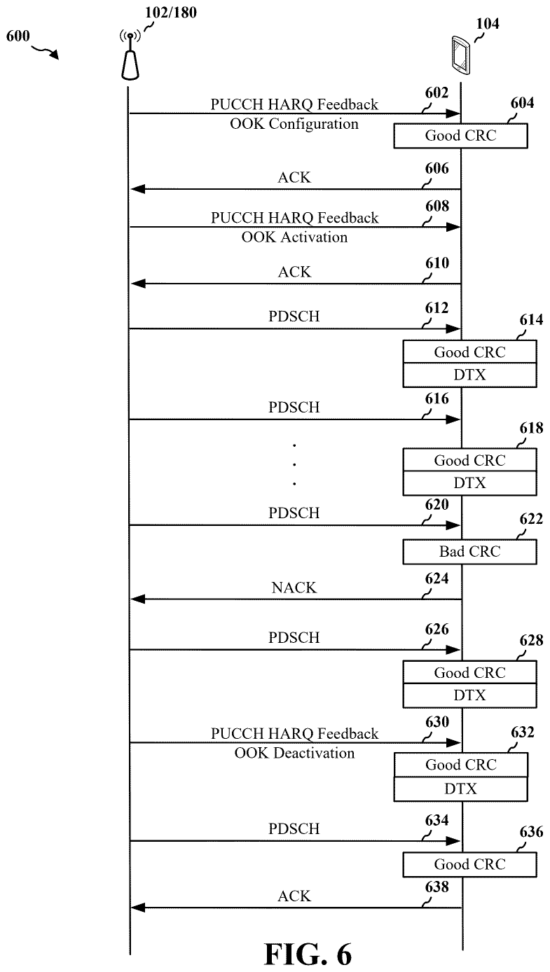

FIG. 6 is a call-flow diagram illustrating an example of communications 600 between a UE 104 (e.g., UE 104 of FIGS. 1 and 3) and a network entity 102 (e.g., base station 102/gNB 180 of FIGS. 1 and 3, or RU 440, DU 430, or CU 410 of FIG. 4). The example communications 600 illustrate using OOK to convey HARQ feedback where all values of the HARQ feedback payload are ACK, in accordance with aspects described herein.

At 602, the network entity 102/180 may transmit a PUCCH HARQ feedback OOK configuration to the UE 104 to configure the UE 104 to use OOK to indicate HARQ feedback. In one example, the configuration may specify a mode to use (e.g., a first mode to use OOK when all HARQ feedback values are ACK). In another example, the configuration may specify one or more parameters for determining when to transmit HARQ feedback regardless of the HARQ feedback values (e.g., a parameter to indicate a number of DCIs after which to transmit HARQ feedback, a defined time window for which to transmit HARQ feedback when a feedback transmission opportunity occurs within or after the time window, etc.). The network entity 102/180 can transmit the configuration using RRC, media access control-control element (MAC-CE), DCI, or similar signaling.

At 604, the UE 104 can detect that the received signal has a good cyclic redundancy check (CRC), which can indicate that the signal sent by the network entity 102/180 at 602 can be decoded. The UE 104 can accordingly send ACK in an upcoming feedback transmission resource as a HARQ feedback payload to the network entity 102/180 at 606. Based on receiving the ACK at 606, the network entity 102/180 can send a signal to the UE 104 at 608 indicating PUCCH HARQ feedback OOK activation. The network entity 102/180 can transmit the activation signal using RRC, MAC-CE, DCI, or similar signaling. The UE 104 can accordingly activate OOK for indicating PUCCH HARQ feedback, as described herein, based on the configuration received at 602. The UE 104 can send an ACK 610 to the network entity 102/180 as HARQ feedback for the activation signal 608. Based on receiving the ACK 610, the network entity 102/180 can process HARQ feedback from the UE 104 based on OOK.

In this regard, for example, the network entity 102/180 can send a PDSCH signal to UE 104 at 612, and the UE 104 can detect a good CRC for the PDSCH at 614. In some examples, the UE 104 can accordingly generate an ACK for the PDSCH 612. As OOK is enabled in the first mode, however, the UE 104 does not transmit (DTX) the ACK. The network entity 102/180 can process ACK feedback for the PDSCH 612 based on not receiving feedback during a corresponding feedback resource. Similarly, for example, the network entity 102/180 can send a second PDSCH signal to UE 104 at 616, and the UE 104 can detect a good CRC for the second PDSCH at 618. In some examples, the UE 104 can accordingly generate an ACK for the PDSCH 616. As OOK is enabled in the first mode, however, the UE 104 does not transmit (DTX) the ACK. The network entity 102/180 can process ACK feedback for the second PDSCH 616 based on not receiving feedback during a corresponding feedback resource.

For example, the network entity 102/180 can send a subsequent PDSCH signal to UE 104 at 620, and the UE 104 can detect a bad CRC for the subsequent PDSCH at 622. The UE 104 can accordingly generate a NACK for the subsequent PDSCH 620. As OOK is enabled in the first mode, at 624, the UE can transmit the NACK in an upcoming feedback transmission resource because all feedback values for the HARQ feedback payload to transmit at 624 are not ACK. The network entity 102/180 can process NACK feedback as received at 624 for the subsequent PDSCH 620. In an example, the network entity 102/180 can retransmit the PDSCH. The PDSCH transmitted at 626 may be the retransmitted PDSCH or a different PDSCH. In any case, the UE 104 can detect a good CRC for the PDSCH at 628. In some examples, the UE 104 can accordingly generate an ACK for the PDSCH 626. As OOK is enabled in the first mode, however, the UE 104 does not transmit (DTX) the ACK.

At 630, the network entity 102/180 can transmit PUCCH HARQ Feedback OOK deactivation signal to the UE 104. The UE 104 can detect a good CRC for the PUCCH HARQ Feedback OOK deactivation signal at 632. In some examples, the UE 104 can accordingly generate an ACK for the PUCCH HARQ Feedback OOK deactivation signal 630. As OOK is enabled in the first mode, however, the UE 104 does not transmit (DTX) the ACK. The network entity 102/180 can transmit the deactivation signal using RRC, media access control-control element (MAC-CE), DCI, or similar signaling, or the UE 104 can determine to deactivate PUCCH HARQ Feedback OOK based on a signal-to-noise ratio (SNR) or other signal metric of the PDSCH (or other signal received from the network entity 102/180) failing to achieve a threshold. In an example, the threshold can be configured by the network entity 102/180 (e.g., in the PUCCH HARQ feedback OOK configuration) and/or can indicate deactivation while the SNR of signals received from the network entity 102/180 fail to achieve the threshold and/or a mode determination when the SNR fails to achieve the threshold for a configured period. The UE 104 can discontinue using OOK to indicate HARQ feedback based on the PUCCH HARQ Feedback OOK deactivation signal or a determination to deactivate PUCCH HARQ Feedback OOK. In this regard, for example, the network entity 102/180 can send a subsequent PDSCH signal to UE 104 at 634, and the UE 104 can detect a good CRC for the subsequent PDSCH at 636 and can accordingly send the ACK at 638 in an upcoming feedback transmission resource based on OOK for HARQ feedback being deactivated.

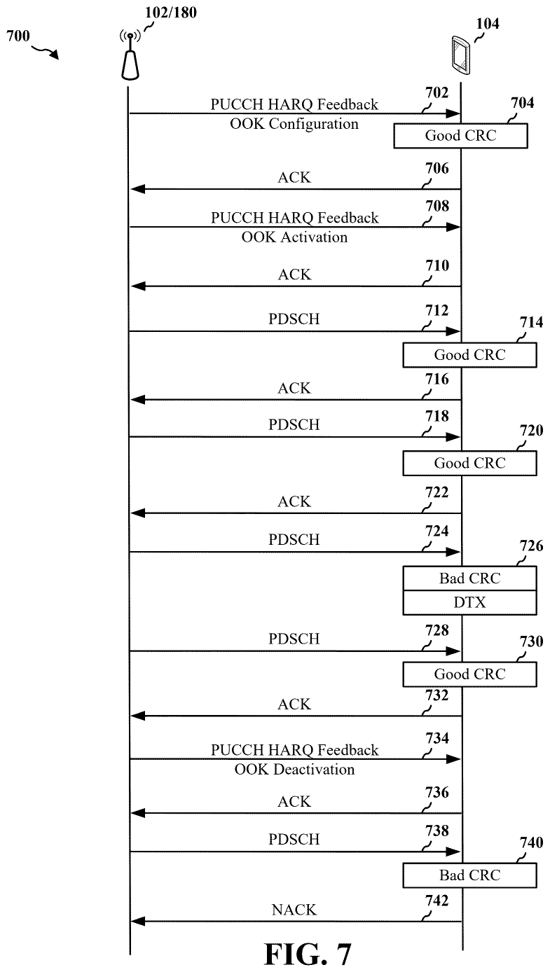

FIG. 7 is a call-flow diagram illustrating an example of communications 700 between a UE 104 (e.g., UE 104 of FIGS. 1 and 3) and a network entity 102 (e.g., base station 102/gNB 180 of FIGS. 1 and 3, or RU 440, DU 430, or CU 410 of FIG. 4). The example communications 700 illustrate using OOK to convey HARQ feedback where all values of the HARQ feedback payload are NACK, in accordance with aspects described herein.

At 702, the network entity 102/180 may transmit a PUCCH HARQ feedback OOK configuration to the UE 104 to configure the UE 104 to use OOK to indicate HARQ feedback. In one example, the configuration may specify a mode to use (e.g., a second mode to use OOK when all HARQ feedback values are NACK). In another example, the configuration may specify one or more parameters for determining when to transmit HARQ feedback regardless of the HARQ feedback values (e.g., a parameter to indicate a number of DCIs after which to transmit HARQ feedback, a defined time window for which to transmit HARQ feedback when a feedback transmission opportunity occurs within or after the time window, etc.). The network entity 102/180 can transmit the configuration using RRC, MAC-CE, DCI, or similar signaling.

At 704, the UE 104 can detect that the received signal has a good cyclic redundancy check (CRC), which can indicate that the signal sent by the network entity 102/180 at 702 can be decoded. The UE 104 can accordingly send ACK in an upcoming feedback transmission resource as a HARQ feedback payload to the network entity 102/180 at 706. Based on receiving the ACK at 706, the network entity 102/180 can send a signal to the UE 104 at 708 indicating PUCCH HARQ feedback OOK activation. The network entity 102/180 can transmit the activation signal using RRC, MAC-CE, DCI, or similar signaling. The UE 104 can accordingly activate OOK for indicating PUCCH HARQ feedback, as described herein, based on the configuration received at 702. The UE 104 can send an ACK 710 to the network entity 102/180 as HARQ feedback for the activation signal 708. Based on receiving the ACK 710, the network entity 102/180 can process HARQ feedback from the UE 104 based on OOK.

In this regard, for example, the network entity 102/180 can send a PDSCH signal to UE 104 at 712, and the UE 104 can detect a good CRC for the PDSCH at 714. The UE 104 can accordingly generate and transmit an ACK for the PDSCH 716. The network entity 102/180 can process ACK feedback for the PDSCH as received at 716. Similarly, for example, the network entity 102/180 can send a second PDSCH signal to UE 104 at 718, and the UE 104 can detect a good CRC for the second PDSCH at 720. The UE 104 can accordingly generate and transmit an ACK for the PDSCH 722. The network entity 102/180 can process ACK feedback for the PDSCH as received at 722.

For example, the network entity 102/180 can send a subsequent PDSCH signal to UE 104 at 724, and the UE 104 can detect a bad CRC for the subsequent PDSCH at 726. In some examples, the UE 104 can accordingly generate a NACK for the subsequent PDSCH 724. As OOK is enabled in the second mode, however, the UE 104 does not transmit (DTX) the NACK. The network entity 102/180 can process NACK feedback for the subsequent PDSCH 726 based on not receiving feedback during a corresponding feedback resource. In an example, the network entity 102/180 can retransmit the PDSCH. The PDSCH transmitted at 728 may be the retransmitted PDSCH or a different PDSCH. In any case, the UE 104 can detect a good CRC for the PDSCH at 730. In some examples, the UE 104 can accordingly generate and transmit an ACK for the PDSCH 732 in an upcoming feedback transmission resource.

At 734, the network entity 102/180 can transmit PUCCH HARQ Feedback OOK deactivation signal to the UE 104. The UE 104 can generate and transmit an ACK for the PUCCH HARQ Feedback OOK deactivation signal 736. The network entity 102/180 can transmit the deactivation signal using RRC, MAC-CE, DCI, or similar signaling, or the UE 104 can determine to deactivate PUCCH HARQ Feedback OOK based on a SNR or other signal metric of the PDSCH (or other signal received from the network entity 102/180) failing to achieve a threshold. In an example, the threshold can be configured by the network entity 102/180 (e.g., in the PUCCH HARQ feedback OOK configuration) and/or can indicate deactivation while the SNR of signals received from the network entity 102/180 fail to achieve the threshold and/or a mode determination when the SNR fails to achieve the threshold for a configured period. The UE 104 can discontinue using OOK to indicate HARQ feedback based on the PUCCH HARQ Feedback OOK deactivation signal or a determination to deactivate PUCCH HARQ Feedback OOK. In this regard, for example, the network entity 102/180 can send a subsequent PDSCH signal to UE 104 at 738, and the UE 104 can detect a bad CRC for the subsequent PDSCH at 740 and can accordingly send the NACK at 742 in an upcoming feedback transmission resource based on OOK for HARQ feedback being deactivated.

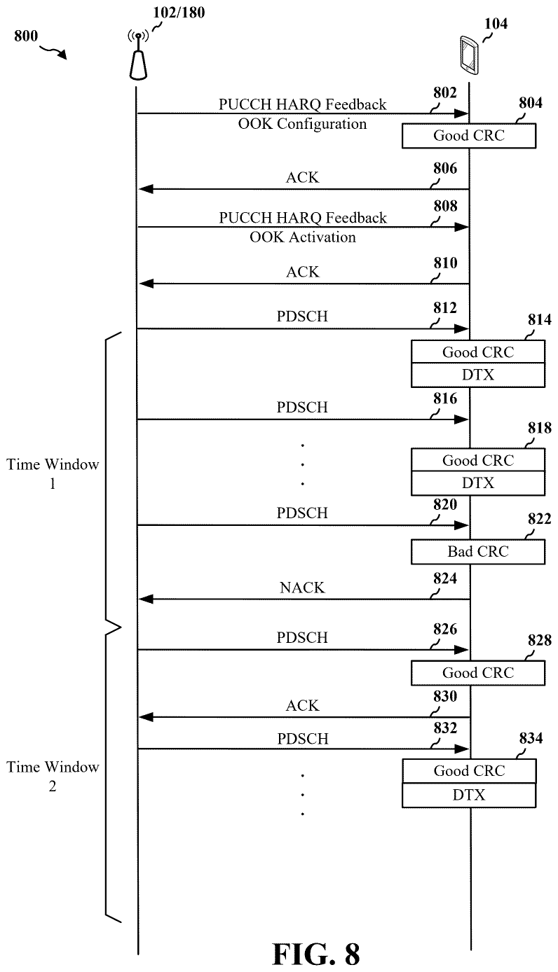

FIG. 8 is a call-flow diagram illustrating an example of communications 800 between a UE 104 (e.g., UE 104 of FIGS. 1 and 3) and a network entity 102 (e.g., base station 102/gNB 180 of FIGS. 1 and 3, or RU 440, DU 430, or CU 410 of FIG. 4). The example communications 800 illustrate using OOK with ambiguity resolution to convey HARQ feedback where all values of the HARQ feedback payload are ACK, in accordance with aspects described herein.

At 802, the network entity 102/180 may transmit a PUCCH HARQ feedback OOK configuration to the UE 104 to configure the UE 104 to use OOK to indicate HARQ feedback, as described at 602 in communications 600 of FIG. 6. At 804, the UE 104 can detect that the received signal has a good cyclic redundancy check (CRC), which can indicate that the signal sent by the network entity 102/180 at 602 can be decoded. The UE 104 can accordingly send ACK as a HARQ feedback payload to the network entity 102/180 at 806. Based on receiving the ACK at 806, the network entity 102/180 can send a signal to the UE 104 at 808 indicating PUCCH HARQ feedback OOK activation, as described at 608 in communications 600 of FIG. 6. The UE 104 can accordingly activate OOK for indicating PUCCH HARQ feedback, as described herein, based on the configuration received at 802. The UE 104 can send an ACK 810 to the network entity 102/180 as HARQ feedback for the activation signal 808. Based on receiving the ACK 810, the network entity 102/180 can process HARQ feedback from the UE 104 based on OOK.

In this regard, for example, the network entity 102/180 can send a PDSCH signal to UE 104 at 812, and the UE 104 can detect a good CRC for the PDSCH at 814. In some examples, the UE 104 can accordingly generate an ACK for the PDSCH 812. As OOK is enabled in the first mode, however, the UE 104 does not transmit (DTX) the ACK. The network entity 102/180 can process ACK feedback for the PDSCH 812 based on not receiving feedback during a corresponding feedback resource. Similarly, for example, the network entity 102/180 can send a second PDSCH signal to UE 104 at 816, and the UE 104 can detect a good CRC for the second PDSCH at 818. In some examples, the UE 104 can accordingly generate an ACK for the PDSCH 816. As OOK is enabled in the first mode, however, the UE 104 does not transmit (DTX) the ACK. The network entity 102/180 can process ACK feedback for the second PDSCH 816 based on not receiving feedback during a corresponding feedback resource.

For example, the network entity 102/180 can send a subsequent PDSCH signal to UE 104 at 820, and the UE 104 can detect a bad CRC for the subsequent PDSCH at 822. The UE 104 can accordingly generate a NACK for the subsequent PDSCH 820. As OOK is enabled in the first mode, at 824, the UE can transmit the NACK in an upcoming feedback transmission resource because all feedback values for the HARQ feedback payload to transmit at 824 are not ACK. The network entity 102/180 can process NACK feedback as received at 824 for the subsequent PDSCH 820. In an example, the network entity 102/180 can retransmit the PDSCH. The PDSCH transmitted at 826 may be the retransmitted PDSCH or a different PDSCH. In any case, the UE 104 can detect a good CRC for the PDSCH at 828.

As the PDSCH 826 is transmitted in a next time window (Time Window 2), the UE 104 can generate and transmit an ACK at 830 in an upcoming feedback transmission resource, regardless of all feedback values being ACK, to provide ambiguity resolution to differentiate from a case when the UE 104 misses DCI detection and accordingly does not send feedback. In this example, sparse PDSCH scheduling can use legacy PUCCH HARQ feedback transmission. In another example, the UE 104 can generate and transmit the ACK at 830 based on the PDSCH 826 corresponding to a nth DCI from the activation of PUCCH HARQ Feedback OOK or from PUCCH HARQ feedback last sent for ambiguity resolution. In this example, fast detection of DCI miss can be enabled.

Other ambiguity resolution mechanism are also possible. For example, the network entity 102/180 can also monitor for PUSCH transmissions from the UE 104 to detect whether the UE 104 is using OOK or is otherwise not receiving DCI/PDSCHs from the network entity 102/180. In another example, the network entity 102/180 can trigger aperiodic sounding reference signal (SRS) or channel state feedback (CSF) signal transmission from the UE 104 and can detect whether the UE 104 is using OOK or is otherwise not receiving DCI/PDSCHs from the network entity 102/180 based on whether the SRS/CSF is received. In yet another example, at least for the first mode of PUCCH HARQ Feedback OOK, for RLC acknowledgment mode (AM), the network entity 102/180 can monitor for unexpected RLC holes, which can be created by false ACKs, and can detect whether the UE 104 is using OOK or is otherwise not receiving DCI/PDSCHs from the network entity 102/180 based on detecting RLC holes.

In any case, following ambiguity resolution, at 832, the network entity 102/180 can transmit a subsequent PDSCH signal to UE 104, and the UE 104 can detect a good CRC for the subsequent PDSCH at 834 and can accordingly send the ACK at 638 based on OOK for HARQ feedback being deactivated. In some examples, the UE 104 can accordingly generate an ACK for the PDSCH 832. As OOK is enabled in the first mode, however, the UE 104 does not transmit (DTX) the ACK. The network entity 102/180 can process ACK feedback for the PDSCH 832 based on not receiving feedback during a corresponding feedback resource.

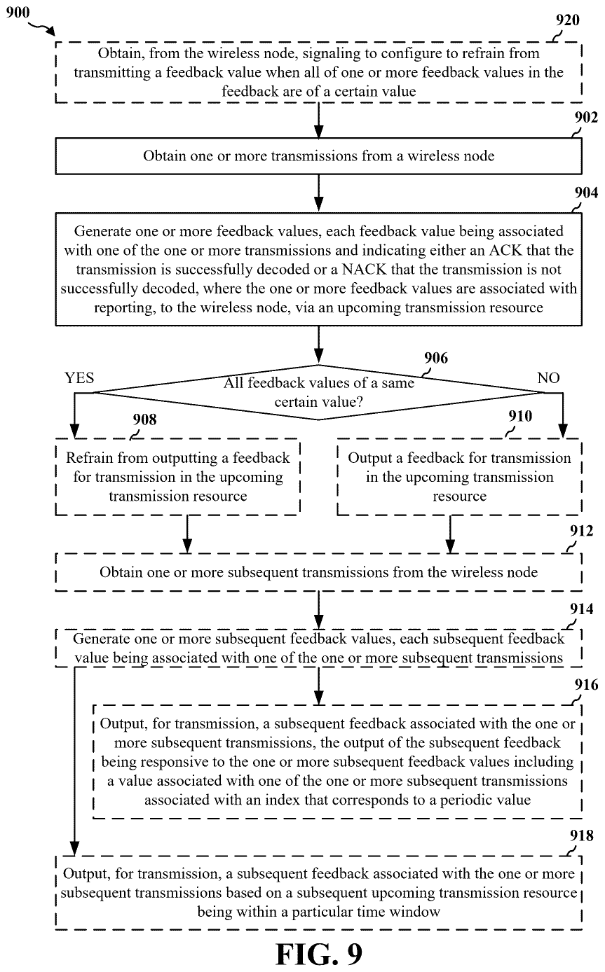

FIG. 9 is a flowchart 900 of a method of wireless communication. The method may be performed by a UE (e.g., the UE 104; the apparatus 1002). Specifically, the method may be performed by one or more memories, processors, and RF front ends (e.g., the memory 360, controller/processor 359, transmitter 354TX, receiver 354RX, antenna 352, etc. of FIG. 3). Optional aspects are illustrated with a dashed line.

Though not shown in this example, the UE 104 can be configured for using OOK for indicating PUCCH HARQ feedback, and/or OOK for indicating PUCCH HARQ feedback can be activated at the UE 104, as described herein.

At 902, the UE may obtain one or more transmissions from a wireless node. For example, 902 may be performed by an obtaining component 1042. Here, the UE may obtain (e.g., receive) one or more transmissions from a network entity 102/180, which may include one or more PDSCHs.

At 904, the UE may generate one or more feedback values, each feedback value being associated with one of the one or more transmissions, and indicating either an ACK that the transmission is successfully decoded or a NACK that the transmission is not successfully decoded, where the one or more feedback values are associated with reporting, to the wireless node, via an upcoming transmission resource. For example, 904 may be performed by the generating component 1044. Here, the UE may determine whether the one or more transmissions are successfully decoded, and can accordingly generate ACK or NACK feedback for each of the one or more transmissions.

At 906, the UE may determine whether all feedback values are of a same certain value (e.g., ACK or NACK depending on which OOK for PUCCH HARQ feedback mode is configured). For example, 906 may be performed by a generating component 1044. Here, the UE 104 can determine whether the feedback values include all ACKs (in the first mode of OOK for PUCCH HARQ feedback) or all NACKs (in the second mode of OOK for PUCCH HARQ feedback). In an example, the upcoming transmission resource can include an uplink resource scheduled for the UE 104, by the network entity 102/180, for transmitting HARQ feedback. In an example, feedback for a portion of the one or more transmissions can be transmitted in the feedback transmission resource based on an offset in time between the transmission and the feedback transmission resource. For example, for a transmission that is received less than the offset before the feedback transmission resource, feedback for that transmission can be associated with a next feedback transmission resource.

At 908, if all feedback values are of the same certain value, the UE may refrain from outputting a feedback for transmission in the upcoming transmission resource. For example, 908 may be performed by an outputting component 1040. Here, the UE may use off keying to indicate that all feedback values are associated with the same certain value.

At 910, if all feedback values are not of the same certain value, the UE may output a feedback for transmission in the upcoming transmission resource. For example, 910 may be performed by an outputting component 1040. Here, the UE may use on keying to indicate that all feedback values are not associated with the same certain value, or to otherwise output the feedback value(s) for transmission. For example, the UE 104 can output the feedback value(s) where at least one feedback value is NACK in OOK for PUCCH HARQ feedback mode 1 or where at least one feedback value is ACK in OOK for PUCCH HARQ feedback mode 2.

At 912, the UE may obtain one or more subsequent transmissions from the wireless node. For example, 912 may be performed by the obtaining component 1042. Here, the UE can obtain one or more subsequent PDSCH transmissions, which may meet the parameters for sending feedback regardless of the feedback value for the purpose of ambiguity resolution.

At 914, the UE may generate one or more subsequent feedback values, each subsequent feedback value being associated with one of the one or more subsequent transmissions. For example, 914 may be performed by the generating component 1044. Here, the UE may determine whether the one or more subsequent transmissions are successfully decoded, and can accordingly generate ACK or NACK feedback for each of the one or more subsequent transmissions.

At 916, the UE may output, for transmission, a subsequent feedback associated with the one or more subsequent transmissions, the output of the subsequent feedback being responsive to the one or more subsequent feedback values including a value associated with one of the one or more subsequent transmissions associated with an index that corresponds to a periodic value. For example, 916 may be performed by an outputting component 1040. Here, the UE may report feedback for certain transmissions associated with the index that corresponds to the periodic value for ambiguity resolution. For example, outputting component 1040 can output feedback for transmission to the network entity 102/180 where the feedback is associated with a transmission that is associated with a nth DCI, as described herein.

At 918, the UE may output, for transmission, a subsequent feedback associated with the one or more subsequent transmissions based on a subsequent upcoming transmission resource being within a particular time window. For example, 918 may be performed by an outputting component 1040. Here, the UE may report feedback for certain transmissions where at least one of the transmissions (or scheduled feedback resources) occur in or based on the defined time window (e.g., a first transmission in a next time window) for ambiguity resolution.

At 920, the UE may obtain, from the wireless node, signaling to configure the UE to refrain from transmitting a feedback value when all of one or more feedback values in the feedback are of a certain value. For example, 920 may be performed by an obtaining component 1042. Here the UE can obtain the signaling from the network entity. The signaling may include a configuration (e.g., RRC signaling with a configuration) indicting to refrain from transmitting feedback values for certain values (e.g., all ACKs or all NACKs), one or more parameters indicating the certain value, and/or the like. In another example, the signaling, or separate signaling (e.g., MAC-CE or DCI signaling), can include a command or other indication to activate the configured functionality to refrain from transmitting feedback in certain scenarios. Outputting component 1040 can output feedback and/or refrain from outputting feedback for transmission based on the signaling.

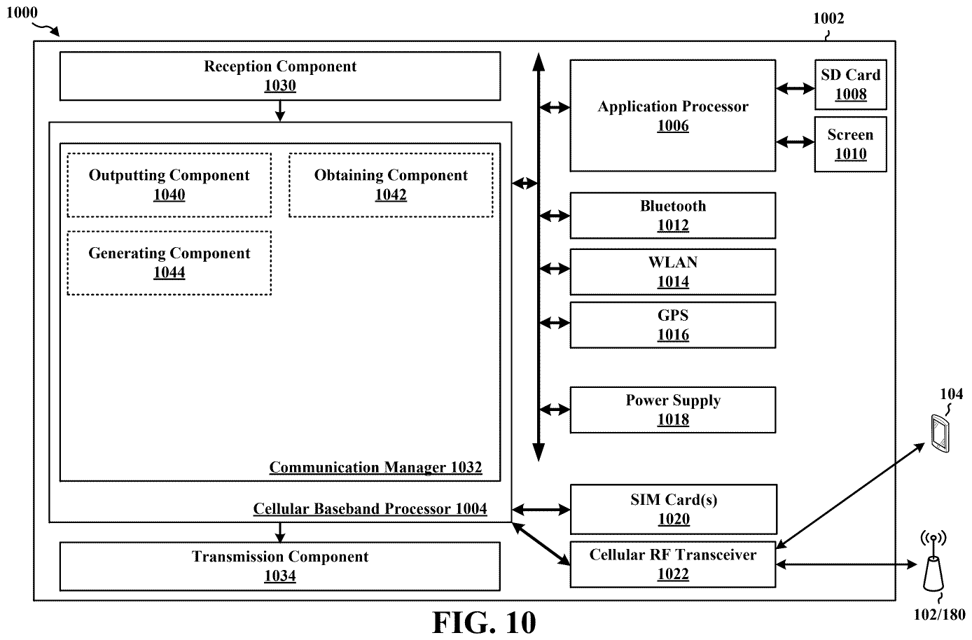

FIG. 10 is a diagram 1000 illustrating an example of a hardware implementation for an apparatus 1002. The apparatus 1002 is a UE and includes a cellular baseband processor 1004 (also referred to as a modem) coupled to one or more cellular RF transceivers 1022 and one or more subscriber identity modules (SIM) cards 1020, an application processor 1006 coupled to a secure digital (SD) card 1008 and a screen 1010, a Bluetooth module 1012, a wireless local area network (WLAN) module 1014, a Global Positioning System (GPS) module 1016, and a power supply 1018. The cellular baseband processor 1004 communicates through the one or more cellular RF transceivers 1022 with the UE 104 and/or BS 102/gNB 180. The cellular baseband processor 1004 may include a computer-readable medium/memory. The computer-readable medium/memory may be non-transitory. The cellular baseband processor 1004 is responsible for general processing, including the execution of software stored on the computer-readable medium/memory. The software, when executed by the cellular baseband processor 1004, causes the cellular baseband processor 1004 to perform the various functions described supra. The computer-readable medium/memory may also be used for storing data that is manipulated by the cellular baseband processor 804 when executing software. The cellular baseband processor 1004 further includes a communication manager 1032. The communication manager 1032 includes the one or more illustrated components. The components within the communication manager 1032 may be stored in the computer-readable medium/memory and/or configured as hardware within the cellular baseband processor 1004. The cellular baseband processor 1004 may be a component of the UE 104 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see UE 104 of FIG. 3) and include the aforediscussed additional modules of the apparatus 1002. The apparatus 1002 can also include a reception component 1030 for receiving communications or other signals obtained by the baseband unit 1004 or one or more components thereof and/or a transmission component 1034 for transmitting communications or other signals output for transmission by the baseband unit 1004 or one or more components thereof

In various examples, the apparatus 1002 can include a chip, SoC, chipset, package or device that may perform one or more of the described functions and may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes an outputting component 1040 that is configured to: output feedback or refrain from outputting feedback based on feedback value, output feedback for certain transmissions regardless of feedback value, etc.; e.g., as described in connection with 908, 910, 916, and 918.

The communication manager 1032 further includes an obtaining component 1042 configured to: obtain transmissions from a wireless node; e.g., as described in connection with 902 and 912. The communication manager 1032 further includes a generating component 1044 configured to: generate feedback values, determine if the feedback values are of a same certain feedback value, etc.; e.g., as described in connection with 904, 906, and 914.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes one or more of means for obtaining, means for generating, means for refraining, means for outputting, or means for deactivating.

The aforementioned means may be one or more of the aforementioned components of the apparatus 1002 configured to perform the functions recited by the aforementioned means. As described supra, the apparatus 1002 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Means for receiving or means for obtaining may include a receiver (such as the receive processor 370) and/or an antenna(s) 320 of the network entity 102/180 or the receive processor 356 and/or antenna(s) 352 of the UE 104 illustrated in FIG. 3, reception component 1030, etc. Means for transmitting or means for outputting may include a transmitter (such as the transmit processor 316) or an antenna(s) 320 of the network entity 102/180 or the transmit processor 368 or antenna(s) 352 of the UE 104 illustrated in FIG. 3, transmission component 1034, etc. Means for obtaining, means for generating, means for refraining, means for outputting, or means for deactivating may include a processing system, which may include one or more processors, such as the controller/processor 359, the memory 360, and/or any other suitable hardware components of the UE 104 illustrated in FIG. 3, baseband unit 1204, communication manager 1232, etc.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

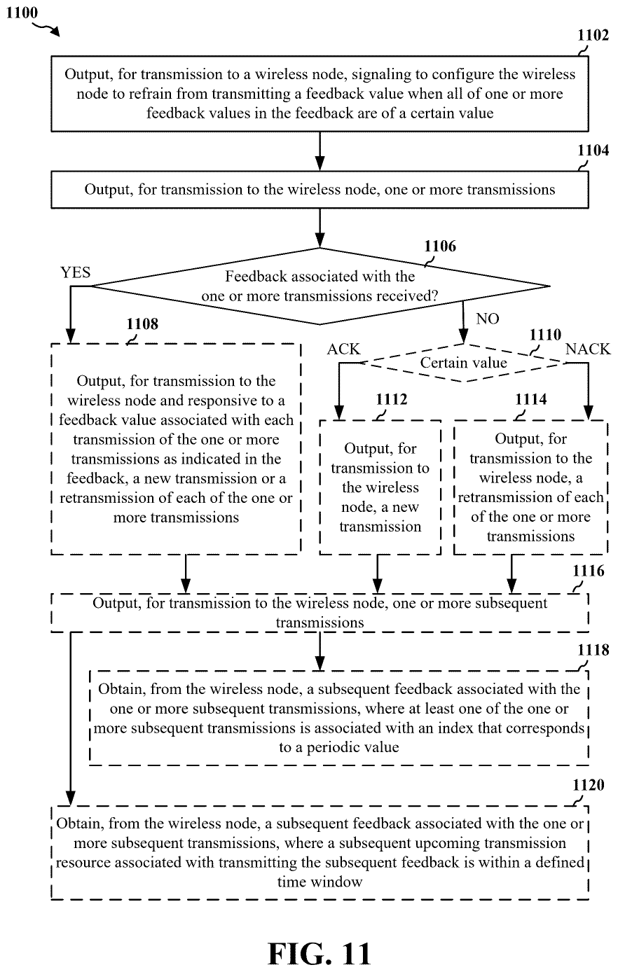

FIG. 11 is a flowchart 1100 of a method of wireless communication. The method may be performed by a network entity or base station (e.g., the base station 102/gNB 180; the apparatus 1202. Specifically, the method may be performed by one or more memories, processors, and RF front ends (e.g., the memory 376, controller/processor 375, transmitter 318TX, receiver 318RX, antenna 320, etc. of FIG. 3). Optional aspects are illustrated with a dashed line.

Though not shown in this example, the network entity can configure the UE 104 for using OOK for indicating PUCCH HARQ feedback, and/or OOK for indicating PUCCH HARQ feedback can be activated by the network entity for the UE 104, as described herein.

At 1102, the network entity may output, for transmission to a wireless node, signaling to configure the wireless node to refrain from transmitting a feedback value when all of one or more feedback values in the feedback are of a certain value. For example, 1102 may be performed by an outputting component 1242. Here the network entity can output the signaling for transmitting to the wireless node (e.g., to a UE 104). The signaling may include a configuration (e.g., RRC signaling with a configuration) indicting to refrain from transmitting feedback values for certain values (e.g., all ACKs or all NACKs), one or more parameters indicating the certain value, and/or the like. In another example, the signaling, or separate signaling (e.g., MAC-CE or DCI signaling), can include a command or other indication to activate the configured functionality to refrain from transmitting feedback in certain scenarios. Outputting component 1242 can output new transmissions or retransmissions for transmission to the wireless node based on the configuration indicated in the signaling.

At 1104, the network entity may output, for transmission to the wireless node, one or more transmissions. For example, 1102 may be performed by an outputting component 1242. Here the network entity can output the one or more transmissions for transmitting to the wireless node (e.g., to a UE 104). The one or more transmissions may include one or more PDSCH or other DL transmissions.

At 1106, the network entity may determine whether feedback associated with the one or more transmissions is received. For example, 1104 may be performed by a obtaining component 1240. Here the network entity can determine whether feedback for a transmission sent to the wireless node is received in a scheduled feedback resource. If not, this can indicate a certain feedback value for at least a portion of the one or more transmissions where OOK for PUCCH HARQ feedback is activated.

At 1110, when feedback is received, the network entity may determine whether the certain value if ACK or NACK (e.g., based on the signaling that configures the functionality output at 1102). For example, 1110 can be performed by obtaining component 1240.

At 1112, when the certain value is ACK (e.g., ACK in OOK for PUCCH HARQ feedback mode 1), a new transmission can be output for transmission to the wireless node. For example, 1112 may be performed by an outputting component 1242. At 1114, when the certain value is NACK (e.g., NACK in OOK for PUCCH HARQ feedback mode 2), a retransmission of each of the one or more transmissions can be output for transmission to the wireless node. For example, 1114 may be performed by an outputting component 1242.

At 1116, the network entity may output, for transmission to the wireless node, one or more subsequent transmissions. For example, 1116 may be performed by an outputting component 1242. Here the network entity can output the one or more subsequent transmissions, where at least one of the one or more subsequent transmissions can satisfy parameters for ambiguity resolution.

At 1118, the network entity may obtain, from the wireless node, a subsequent feedback associated with the one or more subsequent transmissions, where at least one of the one or more subsequent transmissions is associated with an index that corresponds to a periodic value. For example, 1118 may be performed by a obtaining component 1240. Here the network entity obtains feedback for certain transmissions regardless of feedback value for the transmission, such as a transmission associated with an index of a periodic value (e.g., a PDSCH associated with a nth DCI transmitted by the network entity).

At 1120, the network entity may obtain, from the wireless node, a subsequent feedback associated with the one or more subsequent transmissions, where a subsequent upcoming transmission resource associated with transmitting the subsequent feedback is within a defined time window. For example, 1120 may be performed by a obtaining component 1240. Here, the network entity may obtain feedback from the UE 104 for certain transmissions where at least one of the transmissions (or scheduled feedback resources) occur in or based on the defined time window (e.g., a first transmission in a next time window) for ambiguity resolution.

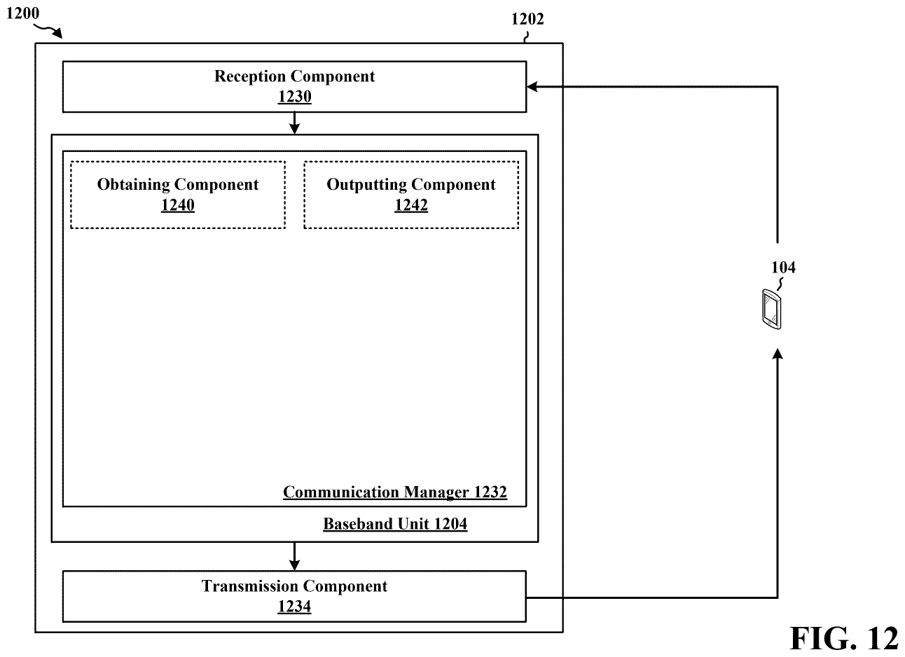

FIG. 12 is a diagram 1200 illustrating an example of a hardware implementation for an apparatus 1202. The apparatus 1202 can be a BS or gNB and includes a baseband unit 1204. The baseband unit 1204 may communicate through one or more cellular RF transceivers with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a communication manager 1232. The communication manager 1232 includes the one or more illustrated components. The components within the communication manager 1232 may be stored in the computer-readable medium/memory and/or configured as hardware within the baseband unit 1204. The baseband unit 1204 may be a component of the BS 102/gNB 180 and may include the memory 376 and/or at least one of the TX processor 316, the RX processor 370, and the controller/processor 375. The apparatus 1202 can also include a reception component 1230 for receiving communications or other signals obtained by the baseband unit 1204 or one or more components thereof and/or a transmission component 1234 for transmitting communications or other signals output for transmission by the baseband unit 1204 or one or more components thereof.

In various examples, the apparatus 1202 can include a chip, SoC, chipset, package or device that may perform one or more of the described functions and may include: one or more modems (such as a Wi-Fi (IEEE 802.11) modem or a cellular modem such as 3GGP 4G LTE or 5G compliant modem); one or more processors, processing blocks or processing elements (collectively “the processor”); one or more radios (collectively “the radio”); and one or more memories or memory blocks (collectively “the memory”).

The communication manager 1232 includes an obtaining component 1240 configured to: determine whether feedback is obtained in a feedback transmission resource, process feedback based on whether the feedback is obtained, obtain feedback for certain transmissions regardless of feedback value for ambiguity resolution, etc.; e.g., as described in connection with 1106, 1110, 1118, and 1120.

The communication manager 1232 further includes an outputting component 1242 configured to output one or more transmissions or other signaling, e.g., as described in connection with 1102, 1104, 1108, 1112, 1114, and 1116.

The apparatus 1202 may include additional components that perform each of the blocks of the algorithm in the aforementioned flowchart of FIG. 11. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes one or more of means for outputting, means for obtaining, means for monitoring, means for discerning, or means for triggering.

The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Means for receiving or means for obtaining may include a receiver, such as the receive processor 370 and/or antenna(s) 320 of the network entity 102/180 illustrated in FIG. 3, reception component 1230, etc. Means for transmitting or means for outputting may include a transmitter such as the transmit processor 316 or antenna(s) 320 of the network entity 102/180 illustrated in FIG. 3, transmission component 1234, etc. Means for outputting, means for obtaining, means for monitoring, means for discerning, or means for triggering may include a processing system, which may include one or more processors, such as the controller/processor 375, the memory 376, and/or any other suitable hardware components of the network entity 102/180 illustrated in FIG. 3, baseband unit 1204, communication manager 1232, etc.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes / flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### EXAMPLE ASPECTS

The following examples are illustrative only and may be combined with aspects of other embodiments or teachings described herein, without limitation.

Example 1 is a method for wireless communications at a first wireless node that includes obtaining one or more transmissions from a second wireless node, generating one or more feedback values, each feedback value being associated with one of the one or more transmissions and indicating either an ACK that the transmission is successfully decoded or a NACK that the transmission is not successfully decoded, where the one or more feedback values are associated with reporting, to the second wireless node, via an upcoming transmission resource, and when all of the one or more feedback values are of a certain value, refraining from outputting a feedback for transmission via the upcoming transmission resource, where the certain value is one of ACK or NACK, or when at least one of the one or more feedback values is different from the certain value, outputting a feedback for transmission via the upcoming transmission resource.

Example 2 is the method of Example 1 including obtaining one or more subsequent transmissions from the second wireless node, generating one or more subsequent feedback values, each subsequent feedback value being associated with one of the one or more subsequent transmissions, and outputting, for transmission, a subsequent feedback associated with the one or more subsequent transmissions, the output of the subsequent feedback being responsive to the one or more subsequent feedback values including a value associated with one of the one or more subsequent transmissions associated with an index that corresponds to a periodic value, where outputting the subsequent feedback is regardless of whether all of the one or more subsequent feedback values in the subsequent feedback are of the certain value.

Example 3 is the method of Example 1 including obtaining one or more subsequent transmissions from the second wireless node, generating one or more subsequent feedback values, each subsequent feedback value being associated with one of the one or more subsequent transmissions, and outputting, for transmission, a subsequent feedback associated with the one or more subsequent transmissions based on a subsequent upcoming transmission resource being within a particular time window, where outputting the subsequent feedback is regardless of whether all of the one or more subsequent feedback values in the subsequent feedback are associated with the certain value.

Example 4 is the method of any of Examples 1-3 including obtaining, from the second wireless node, a configuration indicating whether the certain value is ACK or NACK.

Example 5 is the method of any of Examples 1-4 including obtaining, from the second wireless node, a first command configured to trigger the first wireless node to activate the refrain from outputting the feedback when all of the one or more feedback values are of the certain value.

Example 6 is the method of Example 5 including obtaining, from the second wireless node, a second command configured to trigger the first wireless node to deactivate the refrain activated by the first command.

Example 7 is the method of Example 5 including obtaining one or more subsequent transmissions from the second wireless node, and deactivating the refrain based at least in part on a signal quality of at least one of the one or more subsequent transmissions.

Example 8 is a method for wireless communications at a first wireless node including outputting, for transmission to a second wireless node, signaling to configure the second wireless node to refrain from transmitting a feedback when all of one or more feedback values in the feedback are of a certain value, outputting, for transmission to the second wireless node, one or more transmissions, and when a feedback associated with the one or more transmissions is not obtained from the second wireless node and when the certain value is ACK, outputting for transmission, to the second wireless node, a new transmission, when the feedback associated with the one or more transmissions is not obtained from the second wireless node and when the certain value is NACK, outputting for transmission, to the second wireless node, a retransmission of each of the one or more transmissions, or when the feedback associated with the one or more transmissions is obtained, outputting, for transmission to the second wireless node and responsive to a feedback value associated with each transmission of the one or more transmissions as indicated in the feedback, a new transmission or a retransmission of each of the one or more transmissions.

Example 9 is the method of Example 8 including outputting, for transmission to the second wireless node, one or more subsequent transmissions, and obtaining, from the second wireless node, a subsequent feedback associated with the one or more subsequent transmissions, where at least one of the one or more subsequent transmissions is associated with an index that corresponds to a periodic value.

Example 10 is the method of Example 8 including outputting, for transmission to the second wireless node and via a subsequent upcoming transmission resource, one or more subsequent transmissions, and obtaining, from the second wireless node, a subsequent feedback associated with the one or more subsequent transmissions, where the subsequent upcoming transmission resource is within a defined time window.

Example 11 is the method of any of Examples 8-10 including outputting for transmission to the second wireless node, an activation command to activate the refrain.

Example 12 is the method of Example 11 including outputting, for transmission to the second wireless node, a deactivation command to deactivate the refrain.

Example 13 is the method of any of Examples 8-12 including outputting, for transmission to the second wireless node, one or more subsequent transmissions, where the signaling further configures the second wireless node to deactivate, based at least in part on a signal quality of at least one of the one or more subsequent transmissions, the refrain.

Example 14 is the method of any of Examples 8-13 including outputting, for transmission to the second wireless node, one or more subsequent transmissions, when a subsequent feedback associated with the one or more subsequent transmissions is not obtained from the second wireless node, monitoring for one or more other transmissions from the second wireless node, and discerning, based on whether at least one of the one or more other transmissions is successfully decoded, a value of the subsequent feedback associated with the one or more subsequent transmissions as being of the certain value.

Example 15 is the method of any of Examples 8-13 including outputting, for transmission to the second wireless node, one or more subsequent transmissions, when a subsequent feedback associated with the one or more subsequent transmissions is not obtained from the second wireless node, triggering a transmission of a reference signal from the second wireless node, and discerning, based on whether the reference signal transmission is successfully decoded, a value of the subsequent feedback associated with the one or more subsequent transmissions as being of the certain value.

Example 16 is the method of any of Examples 8-13 including outputting, for transmission to the second wireless node, one or more subsequent transmissions, when a subsequent feedback associated with the one or more subsequent transmissions is not obtained from the second wireless node, monitoring for one or more transmissions in RLC AM to detect one or more RLC AM acknowledgements, and discerning, based on whether the one or more RLC AM acknowledgement are obtained, a value of the subsequent feedback associated with the one or more subsequent transmissions as being of the certain value.

Example 17 is an apparatus for wireless communications, comprising means for performing a method in accordance with any one of examples 1-7.

Example 18 is an apparatus for wireless communications, comprising means for performing a method in accordance with any one of examples 8-16.

Example 19 is a non-transitory computer-readable medium comprising instructions that, when executed by a wireless node, cause the wireless node to perform a method in accordance with any one of examples 1-7.

Example 20 is a non-transitory computer-readable medium comprising instructions that, when executed by a wireless node, cause the wireless node to perform a method in accordance with any one of examples 8-16.

Example 21 is an apparatus for wireless communications, comprising: one or more memories, individually or in combination, having instructions; and one or more processors, individually or in combination, configured to execute the instructions to cause the apparatus to perform a method in accordance with any one of examples 1-7.

Example 22 is an apparatus for wireless communications, comprising: one or more memories, individually or in combination, having instructions; and one or more processors, individually or in combination, configured to execute the instructions to cause the apparatus to perform a method in accordance with any one of examples 8-16.

Example 23 is a first wireless node (e.g., user equipment (UE)), comprising: one or more transceivers; one or more memories, individually or in combination, having instructions; and one or more processors, individually or in combination, configured to execute the instructions to cause the first wireless node to perform a method in accordance with any one of examples 1-7, where the one or more transceivers are configured to: receive the one or more transmissions; generate the one or more feedback values; refrain from transmitting the feedback; or transmit the feedback.

Example 24 is a first wireless node (e.g., network entity), comprising: one or more transceivers; one or more memories, individually or in combination, having instructions; and one or more processors, individually or in combination, configured to execute the instructions to cause the first wireless node to perform a method in accordance with any one of examples 8-16, where the one or more transceivers are configured to: transmit the signaling; transmit the one or more transmissions; transmit the new transmission; or transmit the retransmission.

What is claimed is:

1. An apparatus for wireless communication, comprising:
one or more memories configured to store instructions; and
one or more processors configured to execute the instructions and cause the apparatus to:
obtain one or more transmissions from a second wireless node;
generate one or more feedback values, each feedback value being associated with one of the one or more transmissions and indicating either an acknowledgement (ACK) that the transmission is successfully decoded or a negative acknowledgement (NACK) that the transmission is not successfully decoded, wherein the one or more feedback values are associated with reporting, to the second wireless node, via an upcoming transmission resource; and
when all of the one or more feedback values are of a certain value, refrain from outputting a feedback for transmission via the upcoming transmission resource, wherein the certain value is one of ACK or NACK; or
when at least one of the one or more feedback values is different from the certain value, output a feedback for transmission via the upcoming transmission resource.

2. The apparatus of claim 1, wherein the one or more processors further cause the apparatus to:
obtain one or more subsequent transmissions from the second wireless node;
generate one or more subsequent feedback values, each subsequent feedback value being associated with one of the one or more subsequent transmissions; and
output, for transmission, a subsequent feedback associated with the one or more subsequent transmissions, the output of the subsequent feedback being responsive to the one or more subsequent feedback values including a value associated with one of the one or more subsequent transmissions associated with an index that corresponds to a periodic value, wherein outputting the subsequent feedback is regardless of whether all of the one or more subsequent feedback values in the subsequent feedback are of the certain value.

3. The apparatus of claim 1, wherein the one or more processors further cause the apparatus to:
obtain one or more subsequent transmissions from the second wireless node;
generate one or more subsequent feedback values, each subsequent feedback value being associated with one of the one or more subsequent transmissions; and
output, for transmission, a subsequent feedback associated with the one or more subsequent transmissions based on a subsequent upcoming transmission resource being within a particular time window, wherein outputting the subsequent feedback is regardless of whether all of the one or more subsequent feedback values in the subsequent feedback are associated with the certain value.

4. The apparatus of claim 1, wherein the one or more processors further cause the apparatus to obtain, from the second wireless node, a configuration indicating whether the certain value is ACK or NACK.

5. The apparatus of claim 1, wherein the one or more processors further cause the apparatus to obtain, from the second wireless node, a first command configured to trigger the first wireless node to activate the refrain from outputting the feedback when all of the one or more feedback values are of the certain value.

6. The apparatus of claim 5, wherein the one or more processors further cause the apparatus to obtain, from the second wireless node, a second command configured to trigger the first wireless node to deactivate the refrain activated by the first command.

7. The apparatus of claim 5, wherein the one or more processors further cause the apparatus to:
obtain one or more subsequent transmissions from the second wireless node; and
deactivate the refrain based at least in part on a signal quality of at least one of the one or more subsequent transmissions.

8. An apparatus for wireless communication, comprising:
one or more memories configured to store instructions; and
one or more processors configured to execute the instructions and cause the apparatus to:
output, for transmission to a second wireless node, signaling to configure the second wireless node to refrain from transmitting a feedback when all of one or more feedback values in the feedback are of a certain value;
output, for transmission to the second wireless node, one or more transmissions; and
when a feedback associated with the one or more transmissions is not obtained from the second wireless node and when the certain value is acknowledgement (ACK), output for transmission, to the second wireless node, a new transmission;
when the feedback associated with the one or more transmissions is not obtained from the second wireless node and when the certain value is negative ACK (NACK), output for transmission, to the second wireless node, a retransmission of each of the one or more transmissions; or
when the feedback associated with the one or more transmissions is obtained, output, for transmission to the second wireless node and responsive to a feedback value associated with each transmission of the one or more transmissions as indicated in the feedback, a new transmission or a retransmission of each of the one or more transmissions.

9. The apparatus of claim 8, wherein the one or more processors further cause the apparatus to:
output, for transmission to the second wireless node, one or more subsequent transmissions; and
obtain, from the second wireless node, a subsequent feedback associated with the one or more subsequent transmissions, wherein at least one of the one or more subsequent transmissions is associated with an index that corresponds to a periodic value.

10. The apparatus of claim 8, wherein the one or more processors further cause the apparatus to:
output, for transmission to the second wireless node and via a subsequent upcoming transmission resource, one or more subsequent transmissions; and
obtain, from the second wireless node, a subsequent feedback associated with the one or more subsequent transmissions, wherein the subsequent upcoming transmission resource is within a defined time window.

11. The apparatus of claim 8, wherein the one or more processors further cause the apparatus to output for transmission to the second wireless node, an activation command to activate the refrain.

12. The apparatus of claim 11, wherein the one or more processors further cause the apparatus to output, for transmission to the second wireless node, a deactivation command to deactivate the refrain.

13. The apparatus of claim 8, wherein the one or more processors further cause the apparatus to:
output, for transmission to the second wireless node, one or more subsequent transmissions,
wherein the signaling further configures the second wireless node to deactivate, based at least in part on a signal quality of at least one of the one or more subsequent transmissions, the refrain.

14. The apparatus of claim 8, wherein the one or more processors further cause the apparatus to:
output, for transmission to the second wireless node, one or more subsequent transmissions;
when a subsequent feedback associated with the one or more subsequent transmissions is not obtained from the second wireless node, monitor for one or more other transmissions from the second wireless node; and
discern, based on whether at least one of the one or more other transmissions is successfully decoded, a value of the subsequent feedback associated with the one or more subsequent transmissions as being of the certain value.

15. The apparatus of claim 8, wherein the one or more processors further cause the apparatus to:
output, for transmission to the second wireless node, one or more subsequent transmissions;
when a subsequent feedback associated with the one or more subsequent transmissions is not obtained from the second wireless node, trigger a transmission of a reference signal from the second wireless node; and
discern, based on whether the reference signal transmission is successfully decoded, a value of the subsequent feedback associated with the one or more subsequent transmissions as being of the certain value.

16. The apparatus of claim 8, wherein the one or more processors further cause the apparatus to:
output, for transmission to the second wireless node, one or more subsequent transmissions;
when a subsequent feedback associated with the one or more subsequent transmissions is not obtained from the second wireless node, monitor for one or more transmissions in radio link control (RLC) acknowledged mode (AM) to detect one or more RLC AM acknowledgements; and
discern, based on whether the one or more RLC AM acknowledgement are obtained, a value of the subsequent feedback associated with the one or more subsequent transmissions as being of the certain value.

17. A method for wireless communications at a first wireless node, comprising:
obtaining one or more transmissions from a second wireless node;
generating one or more feedback values, each feedback value being associated with one of the one or more transmissions and indicating either an acknowledgement (ACK) that the transmission is successfully decoded or a negative acknowledgement (NACK) that the transmission is not successfully decoded, wherein the one or more feedback values are associated with reporting, to the second wireless node, via an upcoming transmission resource; and
when all of the one or more feedback values are of a certain value, refraining from outputting a feedback for transmission via the upcoming transmission resource, wherein the certain value is one of ACK or NACK; or
when at least one of the one or more feedback values is different from the certain value, outputting a feedback for transmission via the upcoming transmission resource.

18. The method of claim 17, further comprising:
obtaining one or more subsequent transmissions from the second wireless node;
generating one or more subsequent feedback values, each subsequent feedback value being associated with one of the one or more subsequent transmissions; and
outputting, for transmission, a subsequent feedback associated with the one or more subsequent transmissions, the output of the subsequent feedback being responsive to the one or more subsequent feedback values including a value associated with one of the one or more subsequent transmissions associated with an index that corresponds to a periodic value, wherein outputting the subsequent feedback is regardless of whether all of the one or more subsequent feedback values in the subsequent feedback are of the certain value.

19. The method of claim 17, further comprising:
obtaining one or more subsequent transmissions from the second wireless node;
generating one or more subsequent feedback values, each subsequent feedback value being associated with one of the one or more subsequent transmissions; and
outputting, for transmission, a subsequent feedback associated with the one or more subsequent transmissions based on a subsequent upcoming transmission resource being within a particular time window, wherein outputting the subsequent feedback is regardless of whether all of the one or more subsequent feedback values in the subsequent feedback are associated with the certain value.

20. The method of claim 17, further comprising obtaining, from the second wireless node, a configuration indicating whether the certain value is ACK or NACK.
